(19) United States
(12) Patent Application Publication
(10) Pub. No.: US 2007/0154625 A1
(43) Pub. Date: Jul. 5, 2007

(54) Method for activating electron emission surface of field emission display

(75) Inventors: Kuei-Wen Cheng, Guanyin Township (TW); Jin-Lung Tsai, Guanyin Township (TW); Shie-Heng Lee, Guanyin Township (TW); Yu-An Li, Guanyin Township (TW); Chun-Yen Hsiao, Guanyin Township (TW)

Correspondence Address: HDSL, 4331 STEVENS BATTLE LANE, FAIRFAX, VA, 22033, US

(73) Assignee: Teco Electric & Machinery Co., Ltd.

(21) Appl. No.: 11/325,526

(22) Filed: Jan. 5, 2006

(51) Int. Cl. B05D 5/12

(52) U.S. Cl. 427/77

(57) ABSTRACT

A method activates the electron emission surface of a field emission display. After an un-activated cathode plate is manufactured, a protective layer is formed by coating a solvent to one face of the electron emission source layer. A coating is applied to the protective layer to form a covering layer on the surface of the electron emission source layer. The covering layer is cured and then a mold-releasing cylinder is used to release the dried film. The surface of the electron emission source layer can be uniformly activated. The electron emission source layer is then baked again to remove the remaining solvent.

### BACKGROUND OF THE INVENTION

The present invention relates generally to a method for activating the electron emission surface of a field emission display. More particularly, the present invention relates to a method for activating electron emission surface with higher efficiency, while the damage of the electron emission source can be prevented.

Conventional triode field emission display includes an anode structure and a cathode structure. There is a spacer disposed between the anode structure and the cathode structure, thereby providing a space and a support for the vacuum region between the anode structure and the cathode structure. The anode structure includes an anode substrate, an anode conducting layer, and a phosphorus layer. The cathode structure includes a cathode substrate, a cathode conducting layer, an electron emission layer, a dielectric layer and a gate layer.

The electron emission layer is composed of carbon nanotubes. Since carbon nanotubes, proposed by Iijima in 1991 (Nature, 354, 56 (1991)), comprises very good electronic properties that can be used to build a variety of devices. The carbon nanotubes also has a very large aspect ratio, mostly larger than 500, and a very high rigidity of Young moduli larger than 1000 GPn. In addition, the tips or defects of the carbon nanotubes are of atomic scale. The properties described above are considered an ideal material for building electron field emitter, such as an electron emission source of a cathode structure of a field emission display. Since the carbon nanotubes comprise the physical properties described above, a variety of manufacturing process can be developed, e.g. screen printing, or thin film processing.

However, the art of manufacturing the cathode structure employs carbon nanotubes as an electron emission material, which is fabricated on the cathode conducting layer. The manufacturing process can employ chemical vapor deposition (CVD) process, or any kind of process that can pattern the photosensitive carbon nanotube solution on any pixel of the cathode conducting layer. Moreover, the cathode structure can also be manufactured by coating the carbon nanotubes solution while incorporating with a mask, or depositing the carbon nanotubes on the cathode conducting layer by an electrophoresis method. Nonetheless, the cathode structure needs to be sintered in a 550° C. oven, so as to remove the residual solvent left on the cathode structure and to enhance the adhesion of the carbon nanotubes affixed on the cathode conducting layer.

In general, a so-called surface activation process is needed after the high temperature sintering process. Since the high temperature sintering process still cannot remove other non-nanotube carbon bulks, other non-crystalline carbon nanotube, other bulky carbon balls, or other organic materials formed during the high temperature sintering process on the electron emission surface. The impurities described above can affect the electron production rate of the carbon nanotube electron emitter. The conventional processing methods can be classified as follows. The first approach uses thermal treatment for oxidation. For example, laser or ion beams can be used to expose underlying nanotube. The second approach uses surface thermal treatment to crack or decompose the aggregated material in order to expose underlying nanotube. The third approach uses paste to remove non-effective aggregated material. In above-mentioned approaches, the third approach has prominent effect with low cost.

One conventional method is disclosed in the Taiwanese publication no. 480537. The film peeling process after the adhesion thereof uses a type to adhere on the surface of the electron emission source. The tape is then peeled off to remove the residue materials described above, thereby achieving the activation purpose. Another conventional method is disclosed in the Taiwanese letters patent no. I223308. This method uses a thermal glue or a soluble paint to perfuse onto each pixel of the triode structure on the surface of the electron emission source. The thermal glue is peeled off after curing, so as to activate the surface of electron emission source. Moreover, a patent application filed by the same applicant as the present invention uses spraying process to spray polymer material to the triode structure and then removes the molten glue or the covered film, thus activating the electron emission layer.

However, the method as described above still involves disadvantages. A considerable amount of nanotube can be attached on the cathode electrode after surface material is removed by tape processing. In electron emission source made by screen printing, the nanotubes are formed by sintering glass powder or silver power to attach the nanotubes on the cathode electrode. Moreover, various methods to form nanotubes as electron emission source are proposed. For example, spraying and electrophoresis deposition are proposed beside screen printing and CVD growth. However, the attaching ability of the electron emission source to the cathode electrode are different, depending on the manufacture technologies. The above-mentioned methods cannot provide satisfactory result for electron emission source activated by tape process.

FIG. 1 shows a cross sectional view of a cathode plate 1 after sintering and before tape activation. The layer structure of the cathode plate 1 includes a substrate 2 with an electrode layer 3 thereon, an attach layer 4 adjacent to the electrode layer 3 and mainly composed of glass powder, silver powder and nanotubes, a nanotube-based electron emission layer 5 adjacent to the attach layer 4 and mainly composed of nanotubes. A non-effective material layer 51 is adjacent to the electron emission layer 5 and mainly composed of high-temperature sintered carbon block. The conventional tape activation process removes the non-effective material layer 51 to expose the nanotube structure and facilitate the emission of electron beam.

The nanotube-based electron emission layer 5 mainly includes nanotube with loose structure, while the non-effective material layer 51 is compact structure after sintering. Therefore, the structural force of the nanotube-based electron emission layer 5 is far smaller than that of the structure layer atop it and below it. The structure of the nanotube-based electron emission layer 5 will be damaged in the conventional tape activation process. The non-effective material layer 51 will be removed by the conventional tape activation process, while the nanotube structure of the nanotube-based electron emission layer 5 will be exposed to achieve surface activation. However, the conventional tape activation process is achieved by hot melting, or the polymer spraying process, which is not satisfactory.

The major drawback of above-mentioned prior art is that the solvent may be coated not only on outer surface of the non-effective material layer 51, but also the nanotube-based electron emission layer 5 during the molding or spraying solvent process. The solvent may be even coated to the attach layer 4. The molten glue or the polymer material will substantially fill each layer of the electron emission layer when the molten glue or the polymer material is cured. The nanotube-based electron emission layer 5 will be damaged, the non-effective material layer 51 and part of the nanotubes will be removed during the film peeling process. The electron emission source in a pixel will be removed or damaged. The uniformity of picture will be influenced.

### SUMMARY OF THE INVENTION

The present invention is to solve the problem of damage of electron emission source in a pixel, when a molten glue or polymer is used to surface activate a cathode electron emission source based on triode structure. Therefore, in the present invention, a protective layer is formed for the nanotube structure in the electron emission source layer before the molten glue or polymer is injected. Therefore, the injected molten glue or polymer will be limited to partial portion of the nanotube and the non-effective structure. The most part of nanotubes will be preserved in the electron emission source layer. The activation process will not remove the prominent portion of the nanotubes in the electron emission source layer. The protective layer can then be removed and the characteristic of the electron emission source will not be influenced.

Accordingly the present invention provides a method for surface-activating electron emission source layer of a field emission display. The method comprises following steps.

After an un-activated cathode plate is manufactured, a protective layer is formed by coating a solvent of ethanol to one face of the electron emission source layer. The surface is subjected to heat treatment to remove the solvent in partial portion of the nanotube and the non-effective structure. The protective layer remains only on the surface of the electron emission source layer and around the electron emission source layer.

A coating is prepared by an aqueous solution and is atomized by a spray gun with high air pressure and sprayed on the cathode plate. The coating process can be repeatedly performed because the coating is prepared by an aqueous solution. Therefore, the coating can be substantially formed on the surface of the electron emission source layer.

After the coating is coated on the cathode plate, a baking is performed for several minutes for curing the covering layer. A mold-releasing cylinder is used for mold releasing and the surface of the electron emission source layer can be uniformly activated. The remaining solution in the electron emission source layer can be removed by a following baking step.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the sectional view of the cathode structure according to the present invention.

FIG. 2 is a sectional view of forming protective layer on cathode plate.

FIG. 3 is a sectional view of applying coating on cathode plate.

FIG. 4 is a sectional view of peeling off the covering layer from the cathode plate.

FIG. 5 is a sectional view of activated cathode plate.

### DETAILED DESCRIPTION OF THE INVENTION

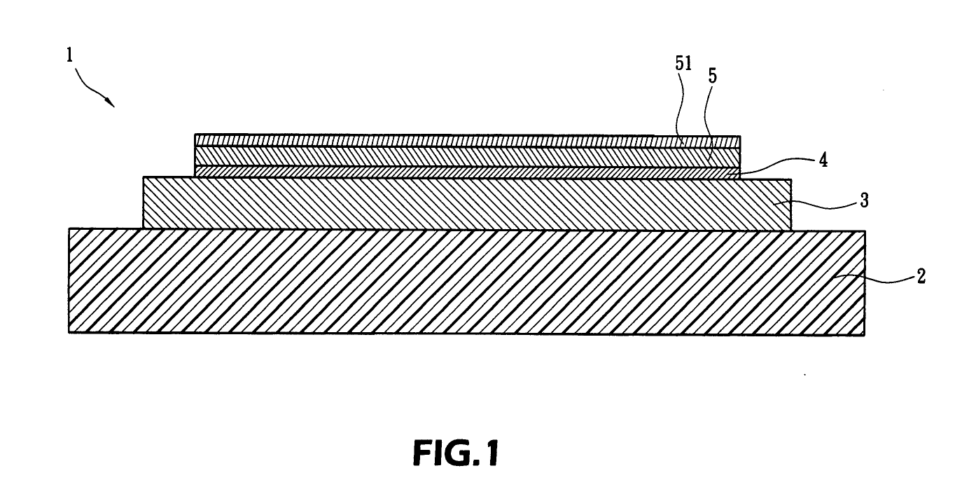

FIG. 1 shows the sectional view of the cathode structure according to the present invention. According to a preferred embodiment of the present invention, a material not solvable with the tape solvent is used as a protective layer and the material can be a solution. The protective layer material is impregnated into the nanotube layer by pasting or dipping. A baking or spinning process is then used to remove the protective layer material in non-effective area or near the non-effective area to facilitate the attaching of the adhesive material. Afterward, the protective layer around the nanotube is used for blocking such that the attaching solvent or molten glue will not attach to excessive nanotubes. Therefore, the nanotube can be successfully exposed. After the film is peeled and the part of the nanotubes are removed, the nanotube layer in center layer is exposed and then the solvent of the protective layer is removed by heating.

At first, a cathode plate 1 for the un-activated triode structure is manufactured by providing a substrate 2 of glass material

A silver glue is used to form an electrode layer 3 on the surface of the substrate 2. After the electrode layer 3 is formed, an attaching layer 4 is formed on the surface of the electrode layer 3,

After the attaching layer 4 is finished, an electron emission source layer (nanotube) 5 is formed on the surface of the attaching layer 4.

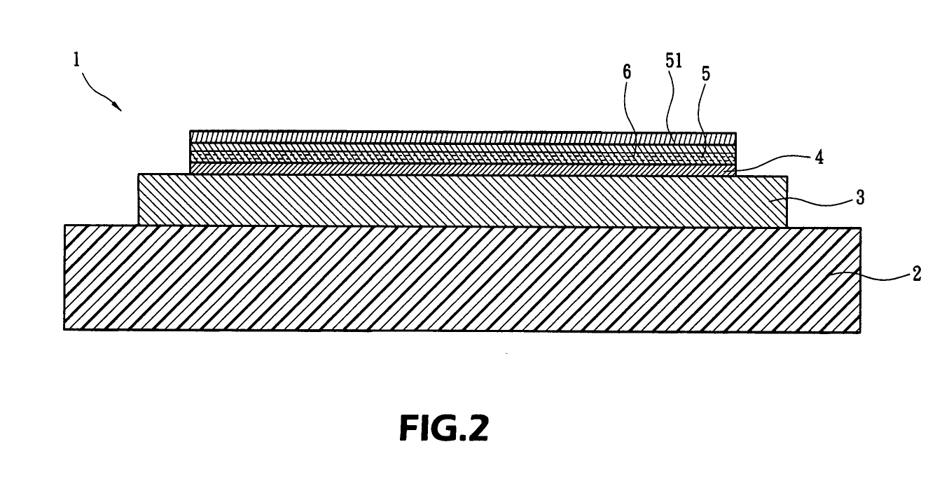

After the un-activated triode structure 1 is finished, a solvent 6 (such as ethanol) is coated on surface of the nanotube-based electron emission layer 5 and is subjected to a heat treatment for 30 seconds by heating at 40° C. As shown in FIG. 2, the ethanol on non-effective material layer 51 of the electron emission layer 5 and on small portion of the nanotube is removed, thus remaining only a small portion of protective layer 6 made of ethanol on the electron emission layer 5 and around the electron emission layer 5.

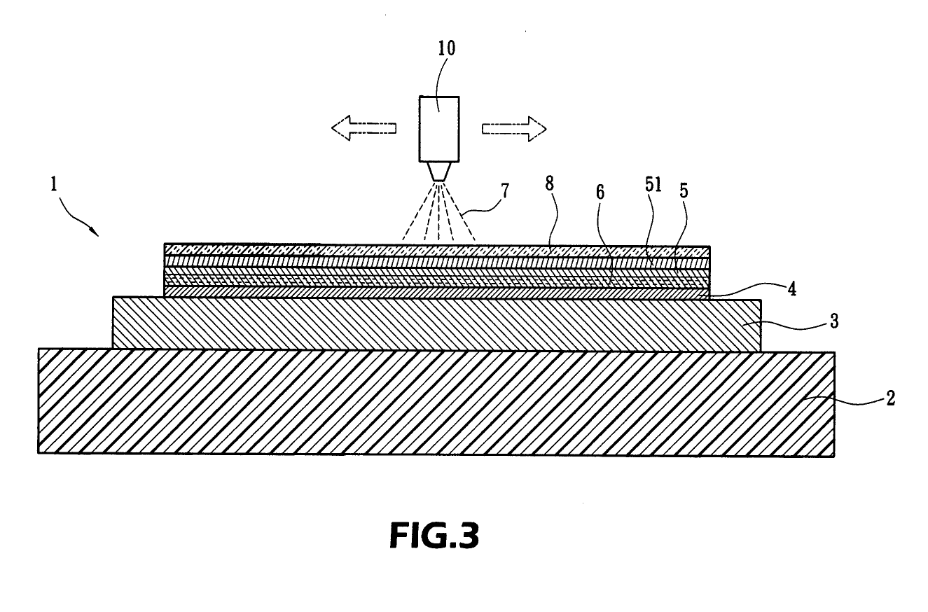

Afterward, a PVA solution or a PVP solution (which can be 5%˜10% liquid solution) is prepared with viscosity below 1000 cps under room temperature, while the viscosity is below 500 cps after heating. As shown in FIG. 3, a spray gun 10 is used with high-pressure air to atomize the liquid solution 7 to spray it on the cathode plate 1. The liquid and suspension ratio in the solution is chosen and the air inflow rate of the spray gun 10 is larger than 200 l/m. The spray solution is a liquid solution and the spray process is repetitive such that the atomized coating 7 can be sufficiently formed on surface of the electron emission layer 5.

Moreover, a covering layer 8 is preferably to have specific thickness such as 0.1˜0.5 mm to facilitate the mold releasing process by a mold-releasing cylinder.

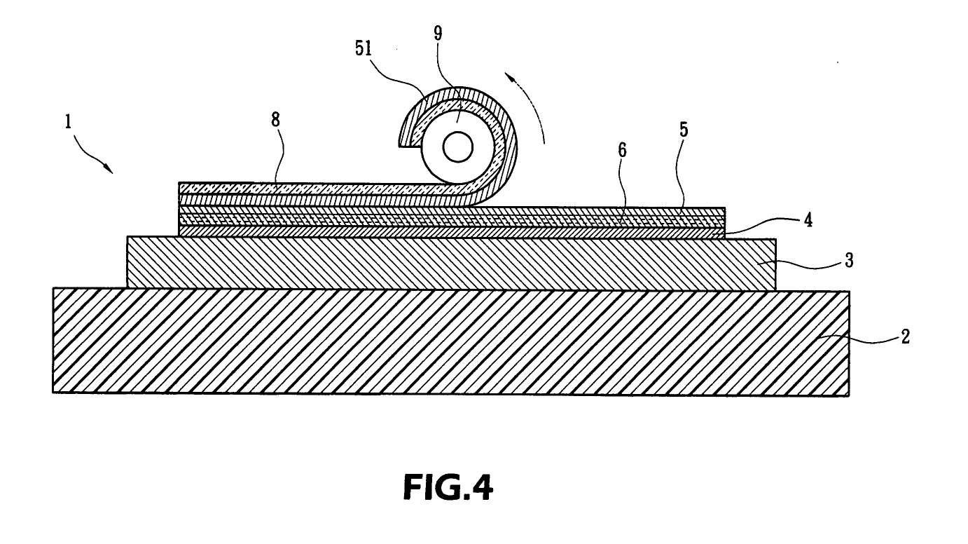

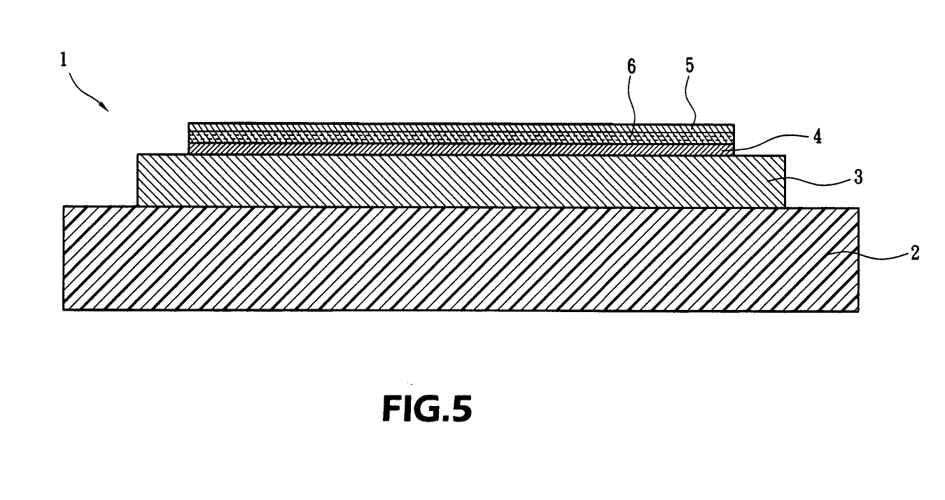

After the coating 7 is coated on the cathode plate 1, a heat treatment of 60˜80° C. and 10˜20 minutes is performed such that the covering layer 8 is dried and cured. A mold-releasing cylinder 9 is used for mold releasing. Therefore, the surface of the electron emission layer 5 is uniformly activated, as shown in FIG. 4. Certain ethanol still remains in the electron emission layer 5 after mold releasing. A heat treatment of 60˜80° C. and 10˜20 minutes baking is performed to remove the remaining ethanol, as shown in FIG. 5.

To sum up, the present invention provides improvement over the activation mechanism of nanotubes with tape attaching process. The pixel to be activated can be preserved and the problem of electron emission source damage caused by over tape of solution can be prevented.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for surface-activating electron emission source layer of a field emission display, comprising
providing an un-activated cathode plate;
forming a protective layer by coating a solvent to one face of the an electron emission source layer and performing surface heat treatment to remove a solvent portion for a non-effective area of the electron emission source layer and a small area for nanotubes, wherein the solvent only remains on the surface of the electron emission source layer and around the electron emission source layer to form the protective layer;
applying a coating to the protective layer to form a covering layer on the surface of the electron emission source layer; and
baking the covering layer to cure the covering layer and then removing the covering layer to uniformly activate the surface of the electron emission source layer; baking again the electron emission source layer again after mold releasing to remove remaining solvent.

2. The method as in claim 1, wherein the cathode plate is of triode structure.

3. The method as in claim 1, wherein the step for providing the cathode plate comprises providing a glass substrate;
forming an electrode layer on the glass substrate by silver paste;
forming an attaching layer on the surface of the electrode layer;
forming an electron emission source layer on the surface of the attaching layer.

4. The method as in claim 3, wherein the electron emission source layer is nanotube.

5. The method as in claim 1, wherein the solvent is ethanol.

6. The method as in claim 1, wherein the protective layer is subjected to heat treatment of 40° C. for 30 seconds to remove a solvent portion for a non-effective area of the electron emission source layer and a small area for electron emission source layer.

7. The method as in claim 1, wherein a spray gun is used to atomize coating by high-pressure gas to apply the coating on surface of the electron emission source layer.

8. The method as in claim 7, wherein an air inflow rate for the spray gun is at least 200 l/min.

9. The method as in claim 1, wherein the coating is one of PVA solution and PVP solution.

10. The method as in claim 1, wherein the coating is an aqueous solution with concentration of 5%˜10%.

11. The method as in claim 1, wherein the viscosity of the coating at room temperature is below 1000 cps.

12. The method as in claim 1, wherein the viscosity of the coating after heating is below 500 cps.

13. The method as in claim 1, wherein the thickness of the covering layer is 0.1˜0.5 mm.

14. The method as in claim 1, wherein the covering layer is mold-released by a mold-releasing cylinder.

15. The method as in claim 1, wherein the cathode plate is heated at 60˜80° C. for 10˜20 minutes to cure the coating.

16. The method as in claim 1, wherein the electron emission source layer is heated at 60˜80° C. for 10˜20 minutes to remove remaining solvent after mold releasing.
